(19) United States
(12) Patent Application Publication
(10) Pub. No.: US 2003/0177818 A1
(43) Pub. Date: Sep. 25, 2003

(54) Gas Water Heater Shut Off Apparatus

(75) Inventor: John M. Bronson, St. Louis, MO (US)

Correspondence Address: Kevin Pumm, White-Rodgers, 9797 Reavis Rd., St. Louis, 63123

(73) Assignee: EMERSON ELECTRIC CO., St. Louis, MO (US)

(21) Appl. No.: 10/250,180

(22) Filed: Jun. 10, 2003

(51) Int. Cl. G01M 3/04

(52) U.S. Cl. 73/49.2

(57) ABSTRACT

An apparatus that operates to detect the presence of a water leak in a gas water heater, and to automatically shut off both an electrically activated water supply valve and a gas shut off means in response to the detection of the leak. The apparatus comprises a float activated electrical switch positioned in a water collection pan located in close proximity to the bottom of the water heater, to control activation of an electrically operated valve for shutting off the supply of water to a gas water heater. The apparatus further comprises a gas shut off means for shutting off the gas supply in response to closure of the float activated electrical switch.

### BACKGROUND OF INVENTION

Residential and commercial gas water heaters are susceptible to eventual failure in a manner such that a substantial volume of water may leak uncontrollably from the water heater tank into the surrounding area of the residential home or building. Water heater tank leaks often occur as a result of the tank corroding, or minerals present in the water supply building up within the tank. The mineral build up can impair temperature sensing and lead to an elevated water temperature that causes a pressure relief valve to repeatedly open and leak water to the surrounding area. This can result in substantial flooding and extensive damage to the building if the manual shut-off valve to the water heater is not closed immediately. A number of attempts have been made to provide a system for automatically shutting off the water supply to the water heater in the event of a leak. Examples of these include Carroll, U.S. Pat. No. 6,543,471; and Parlante, U.S. Pat. No. 6,035,699. The apparatus disclosed in Parlante employs a float activated electrical switch positioned in a water collection pan to control an electrically activated valve. These systems employ a means for automatically shutting off the water supply to a gas water heater, but do not provide for shutting off the gas supply to the water heater. Such devices will allow a leaking gas water heater to continue heating the water remaining in the tank, which can cause the pressure relief valve to repeatedly open and leak the remaining water into the surrounding area. In another system disclosed in White, U.S. Pat. No. 4,730,637, a pulse generator flow meter is utilized to minimize fluid loss and property damage resulting from ruptured water pipes or a ruptured water heater. This system uses a solid state programmable controller to shut off the water system and gas service, in response to receiving a signal indicating a flow of water above a given rate for more than a given length of time. However, this system involves installation of expensive circuitry and specialized equipment to monitor flow rates over a length of time, and does not provide for sensing intermittent leakage or shutting off a gas water heater that experiences repeated periodic leakage of water through the pressure relief valve. Thus, there is still a need for an easily installable, inexpensive apparatus comprising an improved means for automatically shutting off a ruptured or faulty gas water heater that includes a gas shut off means.

### SUMMARY OF INVENTION

There is provided, in accordance with one aspect of the invention an apparatus that operates to detect the presence of a water leak from a gas water heater, and to automatically shut off both an electrically activated water supply valve and a gas shut off means in response to the detection of the leak. The apparatus of the present invention comprises an inexpensive float activated electrical switch positioned in a water collection pan located in close proximity to the bottom of the water heater, to control activation of an electrically operated valve for shutting off the supply of water as in prior art devices. The apparatus of the present invention further comprises an easily installable gas shut off means for shutting off the gas supply in response to closure of the float activated electrical switch. In the preferred embodiment, the float activated electrical switch controls a gas shut off means comprising a relay device for interrupting the thermocouple voltage typically supplied to a conventional water heater gas valve, which is configured to remain open while connected to the thermocouple voltage source. Interrupting the thermocouple voltage to the existing water heater gas valve will close the gas valve, and provide a means for easily shutting off the supply of gas with minimal modification or installation. In another embodiment of the present invention, the float activated electrical switch controls a gas shut off means comprising a second electrically operated valve for shutting off the supply of gas to the water heater, which is simultaneously actuated with the first electrically operated valve for shutting off the supply of water. In yet another embodiment of the present invention, the float activated electrical switch controls a gas shut off means comprising a relay device for removing power to an electrically operated valve that closes when not electrically actuated, to shut off the gas supply.

It is accordingly an object of the present invention to provide a simple, inexpensive apparatus for preventing flooding that may occur due to a ruptured or faulty gas water heater, by automatically shutting off both the supply of water and gas to the water heater.

It is a further object of the present invention to provide an apparatus for automatically shutting off the supply of gas and water to a ruptured or faulty water heater that is easily installable on existing gas water heater devices.

### BRIEF DESCRIPTION OF DRAWINGS

FIG. 1 is a diagram of a preferred embodiment of the apparatus according to the principles of the present invention.

FIG. 2 is a diagram of an alternate embodiment of the apparatus according to the principles of the present invention.

FIG. 3 is a diagram of another alternate embodiment of the apparatus according to the principles of the present invention.

### DETAILED DESCRIPTION

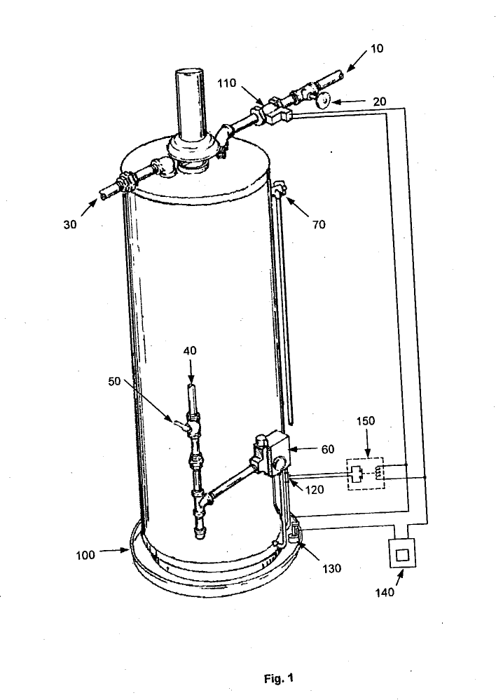

The apparatus according to the principles of the present invention is illustrated in FIG. 1, which shows a water heater having a water supply inlet 10, a manual shut off valve 20, a hot water outlet 30, a gas supply inlet 40, a manual gas shut off valve 50, a water heater gas valve 60, and a pressure relief valve 70. The apparatus also comprises a water collection pan 100 located in close proximity to the bottom of the water heater for collecting water leaking from the water heater tank or pressure relief valve 70, and a float activated electrical switch 130 within the pan 100. The apparatus further comprises an electrically operated valve 110 for shutting off the supply of water to the water heater, and a relay 150 having normally closed contacts for interrupting a thermocouple voltage supplied to the existing water heater gas valve 60. The gas water heater shown is a typical water heater of the type having a thermocouple (not shown) that generates a voltage when a flame is present at the pilot flame. The conventional water heater gas valve 60 is typically configured to remain open when connected to the thermocouple voltage supply. An example of such a gas valve is available as part number 37C75U-368, manufactured by White-Rodgers, a Division of Emerson Electric Co. When the relay 150 is electrically activated, it opens the normally closed contacts for interrupting the thermocouple voltage to the water heater gas valve 60, to close the gas valve 60. An inexpensive adaptive connector 120 allows for simple electrical connection between the conventional water heater gas valve 60 and a typical thermocouple, such that the thermocouple voltage supplied to the gas valve may be interrupted. The adaptive connector 120 of the present invention is shown in FIG. 4, and is preferably an Energy Cut Off for a thermocouple, part number F145-1109 manufactured by White-Rodgers, a Division of Emerson Electric Co. When the float activated electrical switch 120 closes in response to a predetermined amount of water in the pan 100, the float switch 130 switches power from a 24 volt transformer 140 to the electrically operated valve 110 to shut off the supply of water, and switches power to the relay 150 for opening the normally closed contacts that interrupt the thermocouple voltage to the gas valve. 60 to shut off the supply of gas. Thus, the present invention provides for an inexpensive apparatus for automatically shutting off the supply of gas and water to a ruptured or faulty water heater that is easily installable on existing gas water heater devices. It should be noted that this apparatus may not work on all water heater applications, due to a low thermocouple voltage level or reduced current as a result of other devices in the thermocouple circuit.

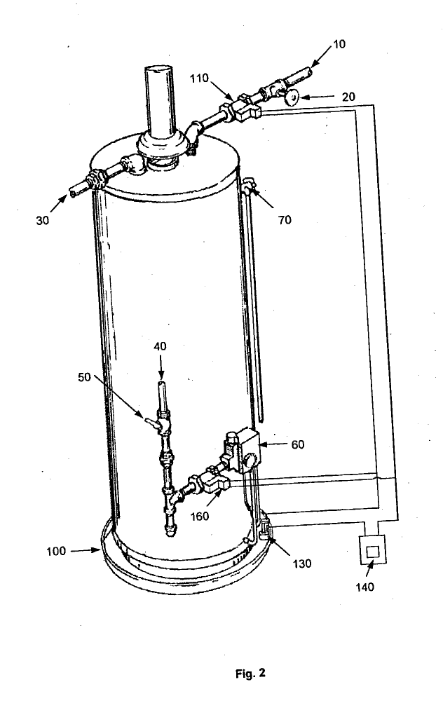

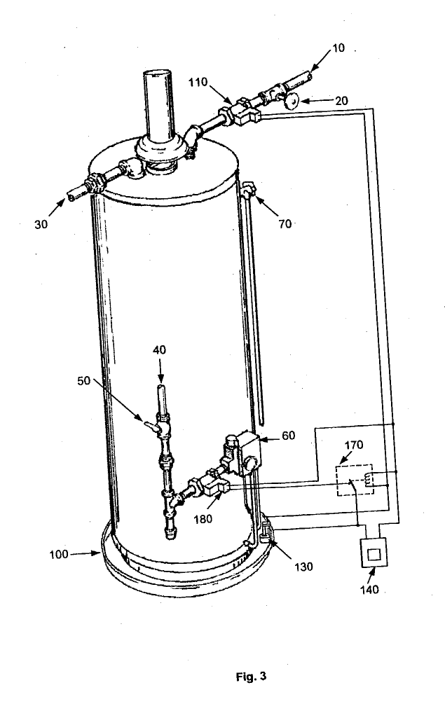

An alternate embodiment of the apparatus is illustrated in FIG. 2, which shows a water heater having a water supply inlet 10, a manual shut off valve 20, a hot water outlet 30, a gas supply inlet 40, a manual gas shut off valve 50, a water heater gas valve 60, and a pressure relief valve 70. The apparatus also comprises a water collection pan 100 located in close proximity to the bottom of the water heater for collecting water leaking from the water heater tank or pressure relief valve 70, and a float activated electrical switch 130 within the pan 100. The apparatus further comprises a first electrically operated valve 110 for shutting off the supply of water to the water heater, and a second electrically operated valve 160 for shutting off the supply of gas to the water heater. When the float activated electrical switch 130 closes in response to a predetermined amount of water in the pan 100, the float switch 130 switches power from a 24 volt transformer 140 simultaneously to the first electrically operated valve 110 to shut off the supply of water, and to the second electrically operated valve 160 to shut off the supply of gas to the inlet of water heater gas valve 60. Because the electrically operated valves 110 and 160 of the subject type that shut off flow in response to electrical activation are well known in the art, the construction and operation of the electrically operated valve will not be described in detail.

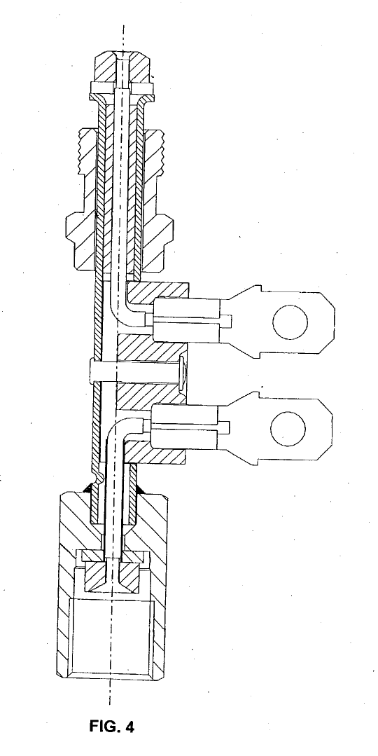

Another alternate embodiment of the apparatus is illustrated in FIG. 3, which shows a water heater having a water supply inlet 10, a manual shut off valve 20, a hot water outlet 30, a gas supply inlet 40, a manual gas shut off valve 50, a water heater gas valve 60, and a pressure relief valve 70. The apparatus also comprises a water collection pan 100 located in close proximity to the bottom of the water heater for collecting water leaking from the water heater tank or pressure relief valve 70, and a float activated electrical switch 130 within the pan 100. The apparatus further comprises a first electrically operated valve 110 for shutting off the supply of water to the water heater, and a relay 170 having a normally closed contact. The relay's normally closed contact provides power from a 24-volt transformer 140 to a second electrically operated valve 180, which shuts off the supply of gas when power is removed from the valve 180. The electrically operated valve 180 is of the manual reset type that requires the valve to be manually pushed open, after which the application of power will hold the valve open. When the float activated electrical switch 130 closes in response to a predetermined amount of water in the pan 100, the float switch 130 switches power from a 24 volt transformer 140 to the first electrically operated valve 110 to shut off the supply of water, and switches power to the relay 170 for opening the normally closed contact to remove power to the second electrically operated valve 180 and shut off the supply of gas. It should be noted that a suitable electronic component may be used in place of the relay device 170 for interrupting the supply of power to the second electrically operated valve 180.

Those skilled in the art will recognize that the inventive apparatus for shutting off a leaking or faulty gas water heater of this invention may be useful in many appliances and heating applications, and is especially useful for control of a gas water heater. Inasmuch as many modifications within the spirit of the invention will be apparent to those skilled in the art, the scope of the invention should be determined by reference to the claims appended below and the full scope of equivalents as provided by applicable laws.

1. An improved apparatus for detecting a water leak and automatically shutting off a gas water heater of the type having a pressure relief valve and a thermocouple for generating a voltage when a flame is present, the apparatus comprising:
an electrically operated valve, wherein the valve shuts off the supply of cold water to the water heater when electrically powered;
a gas valve configured to remain open when connected to the thermocouple voltage source;
a connector means for providing an electrical connection between the gas valve and thermocouple such that the thermocouple voltage supplied to the gas valve may be interrupted through the connector means;
a switching means for interrupting the supply of thermocouple voltage to the gas valve, wherein the switching means is connected to the connector means, and interrupts the thermocouple voltage when the switching means is electrically powered;
a pan located in close proximity to the bottom of the gas water heater for collecting water leaking from the water heater tank or pressure relief valve; and
a water level detection switch means located within the pan for connecting an electrical power source to the switching means-and the electrically operated valve in response to a predetermined amount of water in the pan, such that the switching means interrupts thermocouple voltage to effect closing of the gas valve and the electrically operated valve shuts off the supply of water to the water heater.

2. The improved apparatus of claim 1, wherein the connector means comprises an adapter having a pair of terminals for enabling an electrical connection in series with the gas valve and thermocouple, and is configured to connect to the gas valve and thermocouple connectors.

3. The improved apparatus of claim 1, wherein the switching means comprises a relay having normally closed contacts, wherein the contacts are opened when the relay coil is electrically powered.

4. The improved apparatus of claim 1, wherein the water level detection switching means comprises a float activated electrical switch.

5. An improved apparatus for detecting a water leak and automatically shutting off a gas water heater of the type having a pressure relief valve, the apparatus comprising:
a first electrically operated valve, wherein the valve shuts off the supply of cold water to the water heater when the first valve is electrically powered;
a second electrically operated valve, wherein the second valve shuts off the supply of gas to the water heater when the second valve is electrically powered;
a pan located in close proximity to the bottom of the gas water heater for collecting water leaking from the water heater tank or pressure relief valve; and
a water level detection switch means located within the pan for connecting an electrical power source to the first and second electrically operated valves in response to a predetermined amount of water in the pan, such that the first electrically operated valve shuts off the supply of water to the water heater and the second electrically operated valve shuts off the supply of gas to the water heater.

6. The improved apparatus of claim 5, wherein the first electrically operated valve is configured to shut off the supply of water to the inlet of the water heater gas valve when electrically operated.

7. The improved apparatus of claim 5, wherein the second electrically operated valve is configured to shut off the supply of gas to the inlet of the water heater gas valve when electrically operated.

8. The improved apparatus of claim 5, wherein the water level detection switching means comprises a float activated electrical switch.

9. An improved apparatus for detecting a water leak and automatically shutting off a gas water heater of the type having a pressure relief valve, the apparatus comprising:
a first electrically operated valve, wherein the valve shuts off the supply of cold water to the water heater when the first valve is electrically powered;
a second electrically operated valve, wherein the second valve shuts off the supply of gas to the water heater when the second valve is no longer electrically powered;
a switching means for switching an electrical power source to either the first or second electrically operated valves, wherein electrical power is switched to the Second electrically operated valve when the switching means is not actuated, and electrical power is switched to the first electrically operated valve when the switching means is actuated;
a pan located in close proximity to the bottom of the gas water heater for collecting water leaking from the water heater tank or pressure relief valve; and
a water level detection switch means located within the pan for connecting an electrical power source to actuate the switching means in response to a predetermined amount of water in the pan, such that the first electrically operated valve shuts off the supply of water and the second electrically operated valve shuts off the supply of gas to the water heater.

10. The improved apparatus of claim 9, wherein the first electrically operated valve is configured to shut off the supply of water to the inlet of the water heater tank when electrically operated.

11. The improved apparatus of claim 9, wherein the second electrically operated valve is configured to shut off the supply of gas to the inlet of the water heater gas valve when electrically operated.

12. The improved apparatus of claim 9, wherein the switching means comprises a single pole relay having a normally closed contact, wherein the normally closed contact provides power to the second electrically operated valve, and upon powering the relay coil the normally closed contact is opened to cause the second electrically operated valve to close.

13. The improved apparatus of claim 9, wherein the water level detection switching means comprises a float activated electrical switch.
